(19) United States
(12) Patent Application Publication
(10) Pub. No.: US 2019/0244581 A1
(43) Pub. Date: Aug. 8, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/110,624

(22) Filed: Aug. 23, 2018

(30) Foreign Application Priority Data
Feb. 6, 2018 (JP) 2018-019383

(51) Int. Cl. G09G 5/00; G02B 27/22; G09G 5/14; G09F 19/18

(52) U.S. Cl. CPC G09G 5/003; G02B 27/2292; G09G 3/36; G09F 19/18; G09G 2354/00; G09G 5/14

(57) ABSTRACT

An information processing apparatus includes a display unit that displays an image in a display area that differs from an aerial space and a controller that controls display of an image in a specific aerial space and that, when a user is observed to have approached the specific aerial space, controls the display unit that displays an image in the display area that differs from an aerial space to display an image.

### CROSS-REFERENCE TO RELATED APPLICATIONS

This application is based on and claims priority under 35 USC 119 from Japanese Patent Application No. 2018-019383 filed Feb. 6, 2018.

### BACKGROUND

### (i) Technical Field

The present invention relates to an information processing apparatus and a non-transitory computer readable medium.

### (ii) Related Art

In recent years, technologies for causing an image to appear in the air without using a projector or the like have been developed. The space in the air where an image is displayed is called an “aerial display” because the image is displayed in the air.

### SUMMARY

According to an aspect of the invention, there is provided an information processing apparatus including a display unit that displays an image in a display area that differs from an aerial space and a controller that controls display of an image in a specific aerial space and that, when a user is observed to have approached the specific aerial space, controls the display unit that displays an image in the display area that differs from an aerial space to display an image.

### BRIEF DESCRIPTION OF THE DRAWINGS

An exemplary embodiment of the present invention will be described in detail based on the following figures, wherein:

FIG. 1 depicts the overall configuration of a display system according to an exemplary embodiment;

FIG. 2 is a hardware configuration of a computer that constitutes an information processing apparatus according to the exemplary embodiment;

FIG. 3 is a block diagram of the information processing apparatus according to the exemplary embodiment; and

FIG. 4 illustrates an example of a menu screen and a submenu screen that is displayed in response to a selecting operation on the menu screen, and the menu and submenu screens are displayed on a liquid crystal panel according to the exemplary embodiment.

### DETAILED DESCRIPTION

Hereinafter, an exemplary embodiment of the invention will be described with reference to the drawings.

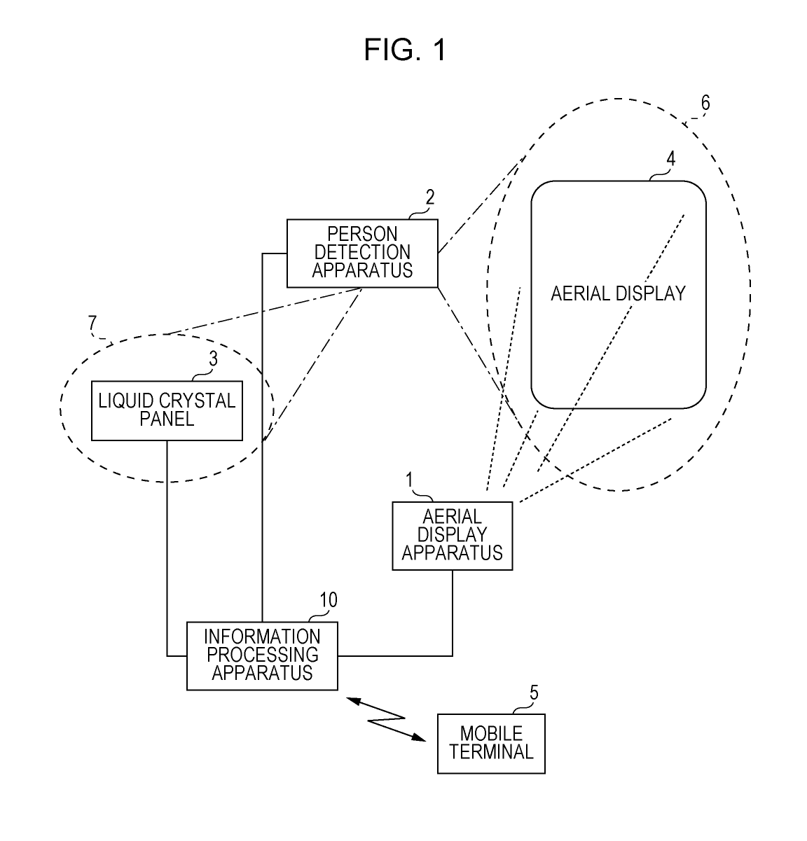

FIG. 1 depicts the overall configuration of a display system according to the present exemplary embodiment. FIG. 1 illustrates an information processing apparatus 10, an aerial display apparatus 1, a person detection apparatus 2, a liquid crystal panel 3, an aerial display 4, and a mobile terminal 5. The information processing apparatus 10 performs total management of the display system including display control of the liquid crystal panel 3 and the aerial display 4 as described in detail below.

The aerial display apparatus 1 and the person detection apparatus 2 are connected to the information processing apparatus 10 wirelessly or with a cable. The aerial display apparatus 1 is a display apparatus capable of displaying an image in three dimensions in a specific space in the air (aerial space). The aerial display apparatus 1 displays an image in the air, for example, by using one or more stationary projectors and a combination of lenses, half mirrors, and the like to form an image by using light. The aerial display apparatus 1 differs from an apparatus that displays moving images by causing optical devices to emit light or a display apparatus that requires a screen. When multiple projectors are used, the projectors project light in different directions to form an image. The projectors are not limited to stationary ones, and a mobile device such as a smartphone may be used for projection. A technique for configuring the aerial display apparatus 1 is not limited to this particular one as long as an image is displayed in the air by using the technique. For example, a technique that uses a supporting device such as eyeglasses is not excluded.

In the present exemplary embodiment, a specific space in the air where an image is displayed by the aerial display apparatus 1 is referred to as an “aerial display”. No display screen, such as the liquid crystal panel 3, is present because an image is displayed in the air. Thus, the size of the aerial display 4 is considered unlimited. However, for example, when an image is displayed in the air by projectors, the extent to which the projectors project light results in a display area for the image and determines the size of the aerial display 4.

In the present exemplary embodiment, descriptions will be given assuming that the aerial display 4 is used as a digital signage display. The term “digital signage” generically refers to a system that presents information by using an electronic presentation device such as a display at any place, for example, outdoors, in retail shops, in public spaces, and on transportation, and the aerial display 4, which is not a physical object, is used in the present exemplary embodiment instead of an electronic presentation device. The aerial display 4, which is expected to be used as a digital signage display, is set up in public places, such as a passage, where people see the aerial display 4.

The liquid crystal panel 3 is installed as a user interface to be used by a person who approaches an image displayed in the aerial display 4. Thus, the liquid crystal panel 3 is disposed at a position inside a predetermined area in the vicinity of the aerial display 4. The position inside the predetermined area is a position, with respect to the aerial display 4, where a person who has approached the aerial display 4 notices the presence of the liquid crystal panel 3 and moves to the position where the liquid crystal panel 3 is disposed so that the person may use the liquid crystal panel 3 immediately. The aerial display 4 displays an image in a place such as a passage, and the liquid crystal panel 3 is desirably disposed close to, for example, a flank (wall) of a passage or the like so that the liquid crystal panel 3 does not hinder the passage of people passing by. In FIG. 1, a single liquid crystal panel 3 is depicted, but multiple units may be disposed depending on a usage pattern, which will be described below.

The liquid crystal panel 3 is installed as a display unit that displays an image and the like in a display area that differs from an aerial space. The liquid crystal panel 3 is also an operation unit to be operated by a user. In the present exemplary embodiment, the liquid crystal panel 3 will be described by way of example as a display unit that provides a display area that differs from an aerial space. However, a display unit that provides a display area that differs from an aerial space is not limited to the liquid crystal panel 3 and may be an information processing apparatus that has a user interface, such as the liquid crystal panel 3, which provides a display area that differs from an aerial space. Such an information processing apparatus may be an apparatus such as a personal computer (PC), a tablet PC, a mobile PC, a smartphone, or a cell phone and is required to have a function to at least transmit data to and receive data from the information processing apparatus 10 wirelessly or via a cable. A PC may have different units for display and operation, for example, a liquid crystal screen as a display unit and a mouse, a keyboard, or the like as an operation unit.

A display unit may be constituted by a flexible display. Flexible displays to be used include a display of an organic electroluminescent type (flexible organic electroluminescent display), a display of an electronic paper type, and a flexible liquid crystal display. Flexible displays that use a display method other than those mentioned here may be used. A flexible display is a display that has a flexibly deformable display portion and that may be bent, folded, rolled, twisted, and stretched, for example. The entire display unit may be constituted by a flexible display, or the display unit may have a flexible display and another functionally or physically separated portion.

The person detection apparatus 2 is an apparatus to detect that a person has approached an image displayed in the aerial display 4. For example, a sensing unit such as an infrared sensor or a pyroelectric sensor may be used, or other methods may be used. It is determined that a person has approached the aerial display 4 if the person enters an area, and such an area is schematically illustrated by dashed line 6 in FIG. 1.

In addition, when a person performs an operation with respect to an image displayed in the aerial display 4, the person detection apparatus 2 detects a position (a portion of the image) at which an operating object points. An operating object is used to point at a portion of an image to perform some operation. An operating object is an object used for performing an operation with respect to an image, such as a fingertip of a person and a pen used by a person.

Further, the person detection apparatus 2 detects that a person has approached a position such that an image displayed on the liquid crystal panel 3 is visually recognizable and operable by the person. In FIG. 1, the area in which a person is required to be to visually recognize an image displayed on the liquid crystal panel 3 is schematically illustrated by dashed line 7. When an image that requests a person to perform some operation is displayed on the liquid crystal panel 3, the area delimited by dashed line 7 indicates the area inside which the person is required to be to perform such an operation. In the present exemplary embodiment, to simplify the description, a single person detection apparatus 2 detects a person who has approached the aerial display 4 or the liquid crystal panel 3 as depicted, but multiple person detection apparatuses 2 may be disposed to individually cover the areas around the aerial display 4 and the liquid crystal panel 3.

The mobile terminal 5 is a terminal apparatus carried by a person who approaches the aerial display 4 (hereinafter, referred to as a user). The mobile terminal 5 is an apparatus such as a smartphone, a cell phone, a mobile PC, or a tablet PC and has a function of transmitting data to and receiving data from the information processing apparatus 10 wirelessly. Examples of the communication method used for transmission and reception include infrared communication, visible-light communication, Wireless Fidelity (Wi-Fi, registered trademark) communication, and short-range wireless communication such as near field communication (NFC). Examples of short-range communication to be used include Felica (registered trademark), Bluetooth (registered trademark), and radio frequency identification (RFID). It is needless to say that other wireless communication methods may be used as the short-range communication. For example, the information processing apparatus 10 may switch communication methods or frequency bands in accordance with a communication counterpart or surrounding environment.

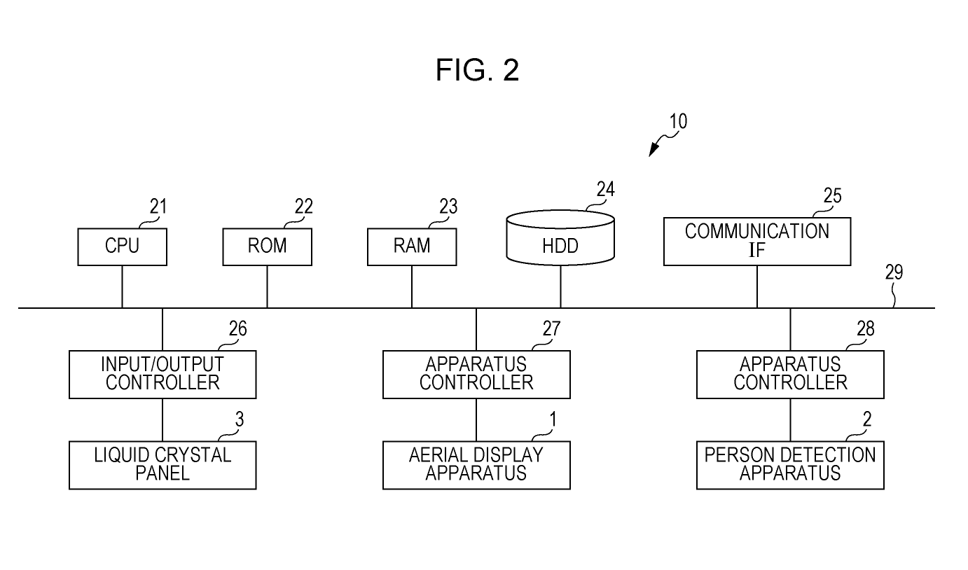

FIG. 2 is a hardware configuration of a computer that constitutes the information processing apparatus 10 according to the present exemplary embodiment. In the present exemplary embodiment, as depicted in FIG. 2, the computer that constitutes the information processing apparatus 10 includes a central processing unit (CPU) 21, a read-only memory (ROM) 22, a random-access memory (RAM) 23, a hard disk drive (HDD) 24, a communication interface (IF) 25, an input/output controller 26 connected to one or more liquid crystal panels 3 wirelessly or with a cable, an apparatus controller 27 connected to the aerial display apparatus 1 wirelessly or with a cable, and another apparatus controller 28 connected to the person detection apparatus 2 wirelessly or with a cable. The CPU 21, the ROM 22, the RAM 23, the HDD 24, the communication IF 25, the input/output controller 26, and the apparatus controllers 27 and 28 are connected to each other via an internal bus 29.

In the present exemplary embodiment, the information processing apparatus 10 is assumed to be constituted by a PC or a server-type computer as a non-limiting example but may be constituted by an apparatus such as a tablet PC, a mobile PC, or a smartphone.

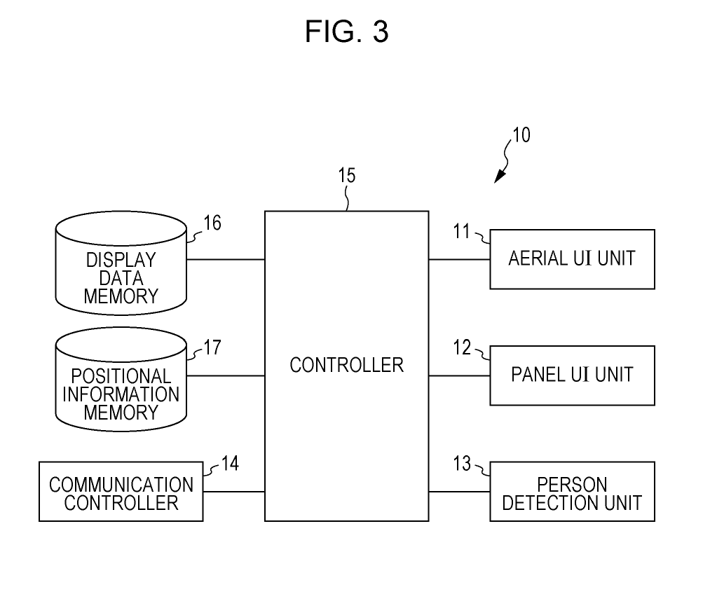

FIG. 3 is a block diagram of the information processing apparatus 10 according to the present exemplary embodiment. The information processing apparatus 10 according to the present exemplary embodiment includes an aerial user interface (UI) unit 11, a panel UI unit 12, a person detection unit 13, a communication controller 14, a controller 15, a display data memory 16, and a positional information memory 17. In FIG. 3, elements that are not used for descriptions of the present exemplary embodiment are omitted.

The aerial UI unit 11 is a user interface unit for the aerial display 4 and includes a device controller and a position determining unit. The device controller causes the aerial display 4 to display an image by controlling the operation of the aerial display apparatus 1 in accordance with display control by the controller 15. When a user detected by the person detection apparatus 2 performs any operation with respect to an image displayed in the aerial display 4, the position determining unit determines the position of an operating object detected by the person detection apparatus 2. When space is represented by three-dimensional coordinates with the origin set to a predetermined position in the aerial display 4, the position determining unit specifies the position of the detected operating object by using a piece of coordinate data. In the present exemplary embodiment, the x-axis is defined as the width direction of the image in the horizontal plane parallel to the ground of a passage, the y-axis is defined as a direction perpendicular to the ground of the passage (height direction of the image), and the z-axis is defined as the depth direction of the image in the horizontal plane parallel to the ground of the passage.

The panel UI unit 12 is a user interface unit realized by the liquid crystal panel 3 and includes a display unit and an operation unit. The display unit displays an image on the liquid crystal panel 3. The operation unit accepts an operation performed on the liquid crystal panel 3 (touch panel). The person detection unit 13 operates in coordination with the person detection apparatus 2 and detects that a user has approached the aerial display 4 or the liquid crystal panel 3. The communication controller 14 controls the communication to and from the mobile terminal 5. The controller 15 controls the operation of each unit of the information processing apparatus 10. The controller 15 functions as a controller and controls display of the aerial display 4 and the liquid crystal panel 3, in particular. In the present exemplary embodiment, the controller 15 is configured to function as a display controller for both the aerial display 4 and the liquid crystal panel 3, but different controllers may be configured to control the aerial display 4 and the liquid crystal panel 3 individually.

The display data memory 16 stores images to be displayed in the aerial display 4 or on the liquid crystal panel 3. In the present exemplary embodiment, it is assumed that the aerial display 4 is used as a digital signage display, and thus images to be displayed are images associated with information relating to advertisements for the most part, such as various screen images including, for example, a product image, a product description, a purchase screen, and a menu screen. In addition, guiding information on a venue where the aerial display 4 is displayed, facilities at the venue, the location of the venue, and the like may be provided. Further, an application to be executed on the mobile terminal 5 is stored in the display data memory 16.

Positional information of the location where the aerial display 4 is displayed and positional information of the location where the liquid crystal panel 3 is disposed are registered in the positional information memory 17. The positional information provides a reference with respect to which a user is observed to have approached or moved away from the aerial display 4 or the liquid crystal panel 3. The positional information may be expressed by coordinates with respect to a predetermined reference position or the latitude and the longitude information (positioning information). The terms “approach” and “move away” used in the descriptions of the present exemplary embodiment will be described after the operations are described.

Each of the elements from 11 to 15 in the information processing apparatus 10 is realized by cooperative operation between the computer constituting the information processing apparatus 10 and programs that run on the CPU 21 mounted in the computer. The memory 16 and the memory 17 are realized by using the HDD 24 mounted in the information processing apparatus 10. Alternatively, a memory may be realized by using the RAM 23 or by using an external memory via a network.

The programs used in the present exemplary embodiment may be provided by transmission via a communication unit or in a stored form on a recording medium readable by a computer, such as a compact-disc ROM (CD-ROM) or a Universal Serial Bus (USB) memory. The programs provided by using the communication unit or the recording medium are installed on the computer, and the CPU 21 of the computer executes the programs consecutively to realize various processes.

As described above, in the present exemplary embodiment, it is assumed that the aerial display 4 is used as a digital signage display. Thus, a person (pedestrian or the like walking down a passage) who is drawn to an image (such as an advertisement) displayed in the aerial display 4 approaches the aerial display 4 to look at the image. When an image is displayed in the aerial display 4 by forming the image in the air, the entire displayed image may be thin, and thus the displayed image may be semi-transparent to a degree such that the scene on the other side is visible through the image. Consequently, some displayed content (image, text, and the like) may be difficult to visually recognize from a distance, or even in the vicinity. In particular, some text characters in an image are difficult to read depending on the font and size.

Thus, it is a feature of the present exemplary embodiment that, when a user is observed to be drawn to an image displayed in the aerial display 4 and to have approached the aerial display 4, the liquid crystal panel 3 is controlled to display the image. As described above, the liquid crystal panel 3 is disposed close to the aerial display 4, and the user who has approached the aerial display 4 notices the liquid crystal panel 3 and looks at the display on the liquid crystal panel 3. The user also operates the liquid crystal panel 3. The liquid crystal panel 3 has better visibility than the aerial display 4, and thus the information may be complemented by providing improved visibility of information such as images displayed in the aerial display 4. An example of the complemented information may be the same content as the content displayed in the air, other information, or detailed information.

Next, operations according to the present exemplary embodiment will be described.

The controller 15 reads an image such as an advertisement from the display data memory 16 and instructs the aerial UI unit 11 to cause the aerial display 4 to display the image. In this description, it is assumed that a single image is displayed, rather than switching between multiple images to be displayed.

A user who is drawn to a displayed image (advertisement) approaches the aerial display 4 to look at the displayed content. When the person detection apparatus 2 detects the user who has approached the aerial display 4, the controller 15 instructs the panel UI unit 12 to cause the liquid crystal panel 3 to display the same image as the image displayed in the aerial display 4.

The user, who notices that the same image as the image displayed in the aerial display 4 is displayed on the liquid crystal panel 3, which is disposed in the vicinity of the aerial display 4, moves to a position in front of the liquid crystal panel 3. The aerial display 4 may display a message to guide the user to the liquid crystal panel 3, information indicating the location where the liquid crystal panel 3 is disposed, or the like and may guide the user to the location where the liquid crystal panel 3 is disposed.

As described above, the same image as the image displayed in the aerial display 4 is displayed on the liquid crystal panel 3, and thus the user recognizes that the display on the liquid crystal panel 3 is associated with the display in the aerial display 4. A description will be provided below assuming that one user is guided to the liquid crystal panel 3. In such a case, the liquid crystal panel 3 is exclusively used by the user.

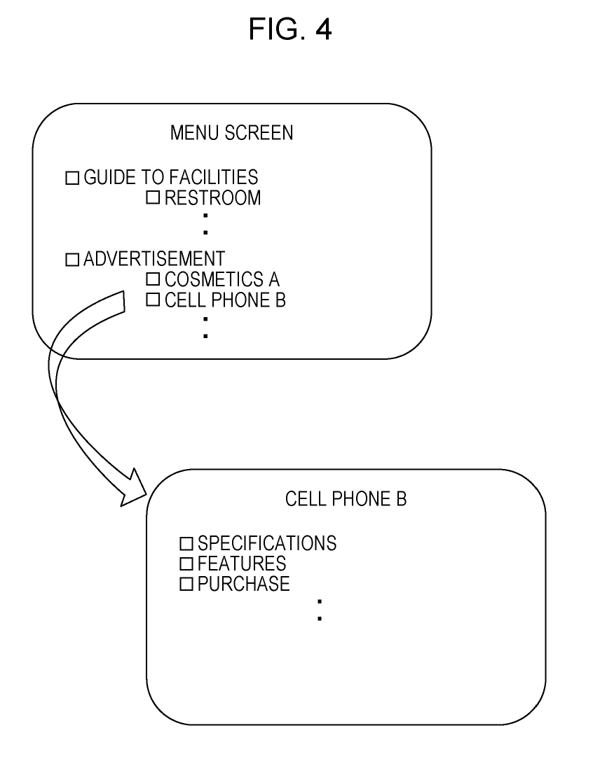

The same image as the image displayed in the aerial display 4 is displayed on the liquid crystal panel 3, and a menu button may be included in this image. The user checks the contents displayed on the liquid crystal panel 3 to clarify illegible text character information and the like displayed in the aerial display 4, and, if the user is interested in a product or the like that is advertised, the user selects a menu button corresponding to the product or the like. In response to the selection, the controller 15 reads a menu screen associated with the displayed image (advertisement) from the display data memory 16 and instructs the panel UI unit 12 to cause the liquid crystal panel 3 to display the menu screen. The menu screen includes, for example, a guide to facilities and information relating to the advertised product. Thus, the controller 15 causes the liquid crystal panel 3 to display information on facilities at the venue where the aerial display 4 is displayed and a list of pieces of information relating to the image (advertisement) displayed in the aerial display 4. The guide to facilities includes the entire floor plan of the venue and information on the locations of facilities such as restrooms and emergency exits. The information relating to the advertised product includes a product line-up. In response to the selection, by the user, of a menu item on the menu screen, the information associated with the selected menu item is displayed. For example, if a product is selected, a submenu screen is displayed, and a detailed description of the product, the price, a button to proceed to a purchase screen, and the like are displayed on the submenu screen. FIG. 4 illustrates an example of a menu screen displayed on the liquid crystal panel 3 and example contents that are displayed when the product selected on the menu screen is “CELL PHONE B”.

The user performs an operation, such as selecting a button, and, in response to the user operation, the controller 15 reads from the display data memory 16 images associated with the user operation (such as a detailed description of the product) and causes the liquid crystal panel 3 to display the images associated with the user operation. When the screen transitions to a purchase screen, for example, the controller 15 launches a corresponding application as required and prompts the user to perform a purchase procedure.

The user is also able to perform an operation with respect to the aerial display 4. For example, the position of an operation button in an image displayed by the aerial display apparatus 1 is compared with the position of a fingertip of the user detected by the person detection apparatus 2, and the fingertip is observed to move in the depth direction (z-axis direction) further from the position where the operation button in the image and the fingertip of the user match. Thus, the user is observed to perform an operation of pushing (selecting) the operation button. The user is unable to actually touch (come into contact with) the aerial display 4 to perform an operation, and thus a user operation screen displayed in the aerial display 4 is regarded as a touch panel that is not able to be touched.

The controller 15 controls the display in the aerial display 4 as follows in accordance with the display of the image on the liquid crystal panel 3 described above. For example, after causing the liquid crystal panel 3 to display the image, the controller 15 terminates the display in the aerial display 4 because the user may find such a display, which is close to the user but is no longer required, to be annoying. This operation leads the user to pay attention to the display on the liquid crystal panel 3. Since only one liquid crystal panel 3 is disposed in this example, no liquid crystal panel 3 is available to other users if the other users are drawn to the display in the aerial display 4. Thus, no further guidance to the liquid crystal panel 3 by using the aerial display 4 is required. The display in the aerial display 4 is terminated after the image is displayed on the liquid crystal panel 3. Alternatively, the display in the aerial display 4 may be terminated after it is confirmed that the user has approached the liquid crystal panel 3. The display in the aerial display 4 may be terminated immediately or after a predetermined period has elapsed after the user is observed to have approached the liquid crystal panel 3.

If multiple liquid crystal panels 3 are disposed or the liquid crystal panel 3 has such a large screen that the screen may be split into multiple screens to display individual images as described below, each of the multiple screens may be assigned to one user. When a display screen is available to another user in this way, the display in the aerial display 4 may be continued.

When the person detection unit 13 detects that the user has moved away from the liquid crystal panel 3, the controller 15 resumes the image display in the aerial display 4 to attract another user. When the user leaves without approaching the liquid crystal panel 3 despite the termination of the display in the aerial display 4 in accordance with the display of the image on the liquid crystal panel 3, that is, when the person detection unit 13 detects that the user has moved away from the aerial display 4, the controller 15 also resumes the image display in the aerial display 4. The image display may be resumed immediately or after a predetermined period has elapsed after the user is observed to have moved away.

In the present exemplary embodiment, the same image as the image displayed in the aerial display 4 is initially displayed on the liquid crystal panel 3 so that the user is easily able to recognize a correspondence between the display on the liquid crystal panel 3 and the display in the aerial display 4. However, this is not limiting, and the liquid crystal panel 3 may be caused to initially display, that is, as the initial screen, an image representing information relating to the image (advertisement) displayed in the aerial display 4, such as the menu screen described above.

As described above, multiple screens may be disposed as a display unit to display the same image as the image in the aerial display 4. For example, multiple liquid crystal panels 3 may be disposed to serve multiple users. As illustrated above, considering that a purchase screen for products is displayed and operated, one screen (the liquid crystal panel 3) is preferably assigned to each user. If the information processing apparatus 10 operates in coordination with a terminal apparatus having the liquid crystal panel 3, process efficiency to serve each user may be improved. In addition, different information is easily provided to each user.

The screen of the liquid crystal panel 3 may be split to provide each user with an individual image (information). For example, in a case where the liquid crystal panel 3 has a relatively large screen, while the first user is looking at an image displayed on the liquid crystal panel 3, if the second user approaches the aerial display 4, the screen of the liquid crystal panel 3 is split, and the split screens are individually assigned to the first user and the second user who approaches the aerial display 4 after the first user approaches the aerial display 4. For example, while one user (for example, user A) is looking at a display on the liquid crystal panel 3, if another user (for example, user B) approaches the aerial display 4, the controller 15 splits the screen of the liquid crystal panel 3 into two portions, which are aligned horizontally. Then, the controller 15 assigns user B one of the split screens of the liquid crystal panel 3, the one being located on the side that user B approaches. For example, if user B approaches the liquid crystal panel 3 from the right-hand side of user A, the split screen on the right is assigned to user B. An image is displayed on the full screen for user A before the screen is split, and the image for user A is displayed on the split screen on the left-hand side after the screen is split. In this way, a single screen may be split into multiple screens to display images.

If still another user (for example, user C) approaches the aerial display 4, the controller 15 splits the screen of the liquid crystal panel 3 into three portions, which are aligned horizontally. Then, if user C approaches the liquid crystal panel 3 from the right-hand side of user B, the split screen at the rightmost position is assigned to user C. The split screen at the leftmost position is assigned to user A, and the split screen at the center is assigned to user B. The number of the split screens need not be equal to the number of the users but may be equal to or larger than the number of the users. When three users are provided with images (information) as in this example, the entire screen may be split into four screens. When the number of formed split screens exceeds the number of users, predetermined information (image) independent of users, for example, an image (such as an advertisement) displayed in the aerial display 4, may be displayed on an unoccupied split screen.

When a user (for example, user A) who is in front of a split screen is observed to move away from the liquid crystal panel 3, the controller 15 may display predetermined information (image), for example, an image (such as an advertisement) displayed in the aerial display 4, on the split screen assigned to user A, who has moved away. Alternatively, image display may be terminated on the split screen assigned to user A.

If only one user is left to look at the liquid crystal panel 3 after some user has moved away from the liquid crystal panel 3, splitting the screen may be terminated. Thus, the display returns to the original single screen, and the liquid crystal panel 3 displays an image serving the user who is in front of the liquid crystal panel 3.

When all the users have moved away from the liquid crystal panel 3, in other words, no user is detected in the vicinity of the liquid crystal panel 3, the controller 15 terminates the display on the liquid crystal panel 3. The controller 15 may cause the liquid crystal panel 3 to terminates the display or may turn off (stop powering) the liquid crystal panel 3 to terminate the display on the liquid crystal panel 3. Alternatively, predetermined information (image), for example, an image (such as an advertisement) displayed in the aerial display 4, may be displayed.

As described above, in the present exemplary embodiment, when multiple users approach the aerial display 4, multiple screens are displayed to serve the multiple users. Alternatively, the multiple users may be served as follows. For example, nowadays, many users carry the mobile terminal 5. Thus, the controller 15 uses as a display unit the mobile terminal 5 carried by a user. Specifically, the controller 15 may send an image to a user, who has expressed an interest, by transmitting the image to the mobile terminal 5 via the communication controller 14 and may cause the mobile terminal 5 to display the image. In such a case, for example, the user is allowed to download a predetermined application to the mobile terminal 5 to receive, display, and operate an image. Thus, the user need not worry about other users peeping an image that the user is looking at with interest. In particular, when the user is required to input personal information on a purchase screen that is displayed, using the mobile terminal 5 for personal use guards the privacy of the user. Alternatively, when the liquid crystal panel 3 is occupied by other users and the user is not able to use the liquid crystal panel 3, an image may be sent to and displayed on the mobile terminal 5 of the user.

In the above description, it is assumed that a single image is displayed in the aerial display 4 rather than switching between multiple images to be displayed. A digital signage display often displays images by periodically switching between multiple images to be displayed. For example, when advertising images A, B, and C are switched and displayed in the aerial display 4 at predetermined intervals, the display on the liquid crystal panel 3 is desirably switched in synchronization with the display in the aerial display 4. Specifically, when the aerial display 4 displays the advertising image A, the liquid crystal panel 3 also displays the advertising image A. When the display in the aerial display 4 switches from the advertising image A to the advertising image B, the display on the liquid crystal panel 3 also switches from the advertising image A to the advertising image B.

Here, it is assumed that a user is drawn to the advertising image A displayed in the aerial display 4 and approaches the aerial display 4 and thereafter the liquid crystal panel 3. It is also assumed that, when the user has approached the liquid crystal panel 3, the display in the aerial display 4 has switched from the advertising image A to the advertising image B, and accordingly, the display on the liquid crystal panel 3 has also switched from the advertising image A to the advertising image B. Then, although the user is drawn to a product in the advertising image A, the liquid crystal panel 3 displays the advertising image B.

Thus, in the present exemplary embodiment, an image selection screen may be displayed on the liquid crystal panel 3 along with an advertising image (A, B, or C). The image selection screen is a screen on which the user is able to select an image from the images to be displayed in the aerial display 4 (the advertising images A, B, and C in the above example). Consequently, the user is able to select the advertising image A, which is desired, on the image selection screen and cause the liquid crystal panel 3 to display the advertising image A or an image (information) relating to the advertising image A.

In addition, when the display on the liquid crystal panel 3 is synchronized with the display in the aerial display 4 (the same switching periods of images are adopted for the aerial display 4 and for the liquid crystal panel 3), in contrast to the above, the display on the liquid crystal panel 3 is not switched at the same time point as the display in the aerial display 4 is switched, but may be switched, for example, at a time point delayed by a certain period. Specifically, although the same switching periods of images displayed in the aerial display 4 and on the liquid crystal panel 3 are adopted, the switching of the display on the liquid crystal panel 3 is delayed, after the display in the aerial display 4 is switched from the advertising image A to the advertising image B, until the user who has looked at the display in the aerial display 4 moves to a position where the liquid crystal panel 3 is disposed and looks at the contents displayed on the liquid crystal panel 3. Such display control provides the user with convenience because the same image as the image displayed in the aerial display 4 is displayed on the liquid crystal panel 3.

Here, the terms “approach” and “move away” used in the descriptions of the present exemplary embodiment will be described.

As described above, it is a feature of the present exemplary embodiment that, when a user is drawn to an image (such as an advertisement) displayed in the aerial display 4 and approaches the aerial display 4, a display unit other than the aerial display 4, for example, the liquid crystal panel 3 in the present exemplary embodiment, is controlled to display an image.

In the present exemplary embodiment, although a user who has approached the aerial display 4 is detected, strictly speaking, a person who only passes by the aerial display 4 is not to be detected. As described above, a person who is drawn to an image displayed in the aerial display 4 and has approached the aerial display 4 with an intention of looking at the image is desirably detected. Thus, the area delimited by dashed line 6 in FIG. 1 is desirably set as a predetermined area that a person is considered to enter when the person approaches the aerial display 4 with an intention of looking at the image displayed in the aerial display 4, rather than an area where the person detection apparatus 2 is able to detect a person. The predetermined area is centered around a display position of the aerial display 4 and a position where the liquid crystal panel 3 is disposed and determined by distances from these positions. These positions are registered in the positional information memory 17. A position of a user is determined in accordance with the information on the user detected by the person detection unit 13. Whether the user has approached the aerial display 4 may be determined in accordance with only the user position determined by the person detection unit 13 (whether the user is in the predetermined area). In addition to this, a combination with other conditions may be used for determination. The conditions include whether the user stays in the predetermined area (delimited by dashed line 6) for a predetermined period and whether the face of the user is facing the image displayed in the aerial display 4 (the line of sight of the user is being directed to the image). Whether a user has approached the liquid crystal panel 3 is determined in a similar manner.

The fact that a user has moved away may be detected when the user has become undetected in the predetermined area (delimited by dashed line 6 or dashed line 7) after the user is observed to have approached the aerial display 4 or the liquid crystal panel 3.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display unit that displays an image in a display area that differs from an aerial space; and
a controller that controls display of an image in a specific aerial space and that, when a user is observed to have approached the specific aerial space, controls the display unit that displays an image in the display area that differs from an aerial space to display an image.

2. The information processing apparatus according to claim 1,
wherein the controller controls display of an image in the specific aerial space in accordance with display of an image on the display unit.

3. The information processing apparatus according to claim 2,
wherein the controller controls display of an image in the specific aerial space to be terminated after the controller causes the display unit to display an image.

4. The information processing apparatus according to claim 3,
wherein the controller resumes display of an image in the specific aerial space when the user is observed to have moved away from at least one of the specific aerial space and the display unit.

5. The information processing apparatus according to claim 2,
wherein the controller controls display of an image in the specific aerial space to be continued when the controller causes the display unit to display an image.

6. The information processing apparatus according to claim 1,
wherein the display unit is disposed in an area predetermined with respect to the specific aerial space.

7. The information processing apparatus according to claim 1,
wherein the display unit has a plurality of screens.

8. The information processing apparatus according to claim 7,
wherein the display unit is constituted by a plurality of terminal apparatuses, each of which includes a screen.

9. The information processing apparatus according to claim 1,
wherein the display unit includes a single screen, and
when one or more other users have approached the specific aerial space while the user is looking at an image displayed on the display unit, the controller splits the single screen of the display unit into a plurality of split screens, such that each of the user and the one or more other users is assigned a different split screen of the plurality of split screens.

10. The information processing apparatus according to claim 9,
wherein the controller assigns one of the one or more other users a split screen of the plurality of split screens of the display unit, the split screen being on a side that the one of the one or more other users approaches.

11. The information processing apparatus according to claim 9,
wherein, when a user has moved away from the specific aerial space, the controller causes a split screen of the plurality of split screens, the split screen being assigned to the user who has moved away, to display predetermined information.

12. The information processing apparatus according to claim 9,
wherein, when only one user is left to look at the display unit because another user has moved away from the display unit, the controller terminates splitting the single screen of the display unit.

13. The information processing apparatus according to claim 4,
wherein the controller causes the display unit to terminate display or causes the display unit to display predetermined information when no user is detected in the vicinity of the display unit.

14. The information processing apparatus according to claim 1,
wherein the display unit is an apparatus that has a display function and is carried by the user.

15. The information processing apparatus according to claim 1,
wherein, when a user has approached the specific aerial space while another user is using the display unit, the controller causes an apparatus carried by the user to display an image.

16. The information processing apparatus according to claim 1,
wherein the controller causes the display unit to display an image representing information relating to an image displayed in the specific aerial space.

17. The information processing apparatus according to claim 16,
wherein, when displaying a plurality of images in the specific aerial space, the controller causes the display unit to display an image representing a list of pieces of information relating to the plurality of images.

18. The information processing apparatus according to claim 1,
wherein, when the display unit also serves as an operation unit operated by a user, the controller causes the display unit to display an image similar to an image of an operation screen displayed in the specific aerial space.

19. A non-transitory computer readable medium storing a program causing a computer to execute a process for information processing, the process comprising:
displaying an image in a display area that differs from an aerial space; and
controlling display of an image in a specific aerial space and, when a user is observed to have approached the specific aerial space, controlling an image to be displayed in the display area that differs from an aerial space.

20. An information processing apparatus comprising:
means for displaying an image in a display area that differs from an aerial space; and
means for controlling display of an image in a specific aerial space and, when a user is observed to have approached the specific aerial space, controlling an image to be displayed in the display area that differs from an aerial space.
